(19) United States
(12) Patent Application Publication
(10) Pub. No.: US 2005/0254929 A1
(43) Pub. Date: Nov. 17, 2005

(54) Pot lift device and method of transport

(76) Inventor: Michael C. Proctor, Parkton, NC (US)

Correspondence Address: Joshua L. Price;Olive & Olive, P.A., P. O. Box 2049, Durham, NC, 27702, US

(21) Appl. No.: 10/844,850

(22) Filed: May 13, 2004

(51) Int. Cl. B65G 1/00

(52) U.S. Cl. 414/607

(57) ABSTRACT

A pot lift device comprising a plurality of elongated, spaced-apart, generally parallel rails extending in a horizontal manner and adapted to be raised and lowered, the rails comprising a leading distal end and a proximal end, the proximal end adapted to be attached to a mobile carrying machine, the proximal end of the rails being connected by a perpendicular cross bar, the rails being spaced apart at a distance greater than a bottom diameter of a pot but less than a top diameter of the pot, the rails having on their top edge a serrated means for griping an underside portion of the top diameter of the pot and a method of transporting a pot comprising providing a plurality of elongated spaced apart generally parallel rails extending in a horizontal manner and adapted to be raised and lowered, the rails comprising a leading distal end and a proximal end, the proximal end adapted to be attached to a mobile carrying machine, the proximal end of said rails being connected by a perpendicular cross bar, the rails being spaced apart at a distance greater than a bottom diameter of a pot but less than a top diameter of the pot, the rails having on their top edge a serrated means for griping an underside portion of the top diameter of the pot.

### BACKGROUND OF THE INVENTION

The present invention relates generally to a pot lift device and method of transport and more particularly to a pot lift device and method of transport comprising two or more rails having a serrated top edge for gripping the underside of the lip of one or more pots, wherein the pots are held in place while the rails are raised, lowered, and moved laterally to a desired location.

### BRIEF DESCRIPTION OF THE DRAWINGS

FIG. 1 is a front perspective view of the invention according to one embodiment.

FIG. 2 is a side elevation view of the invention according to one embodiment.

FIG. 3 is a top view of the invention according to one embodiment.

FIG. 4 is a front elevation view of the invention according to one embodiment.

FIG. 5 is a perspective view of the invention according to one embodiment.

FIG. 6 is a perspective view of the invention according to one embodiment.

FIG. 7 is a side perspective view of the invention according to one embodiment

FIG. 8 is a top view of the invention according to one embodiment.

### DETAILED DESCRIPTION

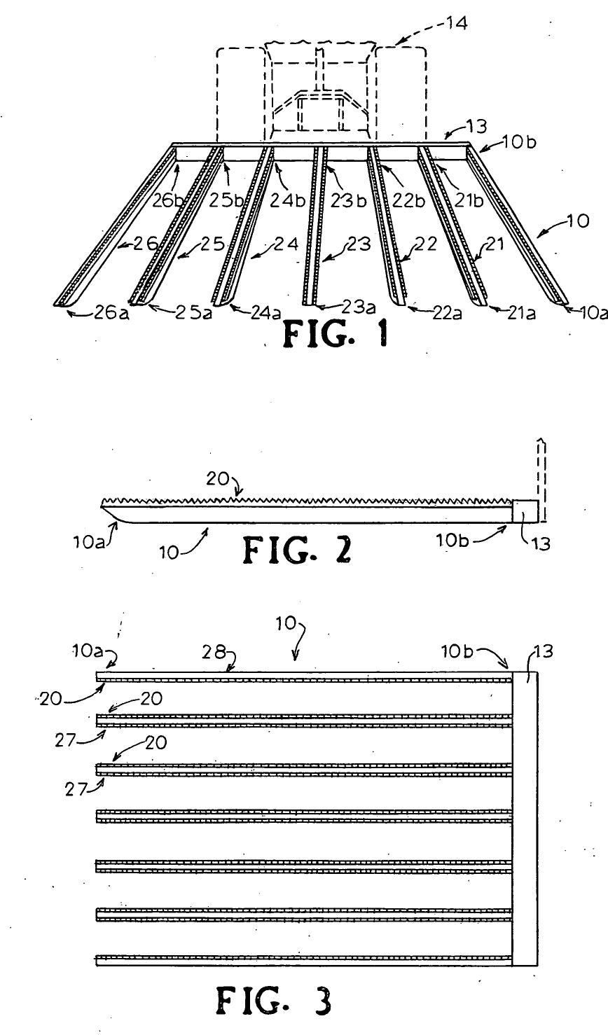

Referring now to FIG. 1, there is shown a front perspective view of the invention according to one embodiment. There is shown a plurality of rails 10, 21, 22, 23, 24, 25, and 26, each having a distal leading end 10a, 21a, 22a, 23a, 24a, 25a, 26a, and a proximal end 10b, 21b, 22b, 23b, 24b, 25b, 26b. The proximal end 10b is attached to a cross bar 13 that connects the proximal end 10b of each rail 10 so that each rail 10 extends from cross bar 13 in a perpendicular fashion. The embodiment shown in FIG. 1 has seven rails, however any number of rails greater than two is preferred. A mobile transporter 14 connects to the cross bar 13 and powers the raising and lowering of the device, as well as the lateral movement of the device.

Referring now to FIG. 2, there is shown a side elevation view of the invention according to one embodiment. There is shown a rail 10, having a distal leading end 10a and a proximal end 10b. The proximal end is connected to a cross bar 13. It is preferred that the distal leading end 10a be tapered to prevent the distal end 10a from digging into the ground. On the top surface of rail 10 there is a serrated edge 20. The serrated edge 20 grips the underside of the lip of the pot, described later.

Referring now to FIG. 3, there is shown a top view of the invention according to one embodiment. There is shown a rail 10, having a distal leading end 10a and a proximal end 10b. The proximal end is connected to a cross bar 13. Each rail 10 has two serrated edges 20 and 27 running the length of the rail 10. It is optional that the rails on the end only have one serrated edge 20, leaving the edge on the outer side 28 without a serrated edge. The serrated edges 20 and 27 grip the underside of the lip of the pot, described later.

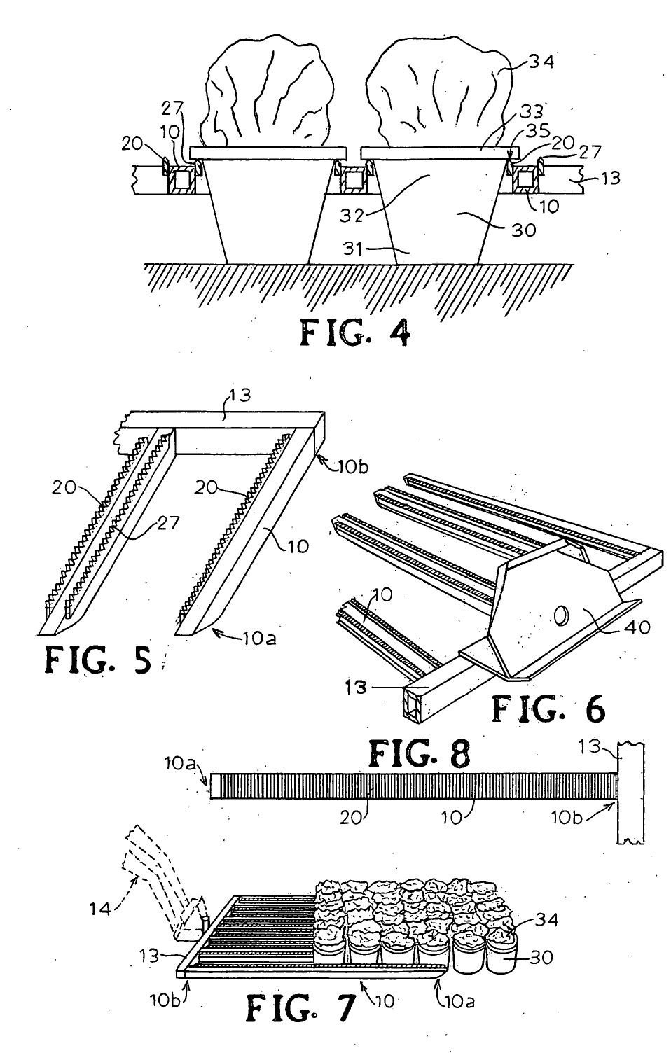

Referring now to FIG. 4, there is shown a front elevation view of the invention according to one embodiment. There is shown a pot 30 having a bottom portion 31 and a top portion 32. The pot 30 may optionally contain a plant 34. The bottom portion 31 of pot 30 is typically smaller in diameter than the top portion 32, but they could also be identical. The top portion 32 of pot 30 has a lip 33 that extends a diameter greater than that of the top portion 32. The lip 33 has an underside portion 35. There is also shown a rail 10 connected to a cross bar 13. Rail 10 has two serrated edges 20 and 27. As the rails are raised, the serrated edge 20 comes into contact with the underside portion 35 of the lip 33 of the top portion 32 of the pot 30. The serrated edge of one rail will support the underside portion of the lip of a pot on one side, while the serrated edge of a second rail will support the underside portion of the lip of the pot on the opposite side.

Referring now to FIG. 5, there is shown a perspective view of the invention according to one embodiment. There is shown a rail 10, having a distal leading end 10a and a proximal end 10b. The proximal end is connected to a cross bar 13. FIG. 5 shows the optional embodiment where the rail on the end only has one serrated edge 20, leaving the edge on the end without a serrated edge.

Referring now to FIG. 6, there is shown a perspective view of the invention according to one embodiment. There is shown a rail 10 connected to a cross bar 13. The cross bar 13 has an optional attachment 40 whereby the device can be connected or coupled to a mobile transporter, according to one embodiment.

Referring now to FIG. 7, there is shown a side perspective view of the invention according to one embodiment. There is shown a rail 10, having a distal leading end 10a and a proximal end 10b. The proximal end is connected to a cross bar 13. The cross bar 13 is connected to a mobile transporter 14. The invention is being shown in a lowered position being moved partially away or towards rows of pots.

Referring now to FIG. 8, there is a shown a top view of the invention according to one embodiment. There is shown a rail 10, having a distal leading end 10a and a proximal end 10b. The proximal end 10b is connected to a cross bar 13. Rail 10 has a serrated top running the length of the rail 10 from the distal leading end 10a to the proximal end 10b. In this embodiment, the majority of the top of rail 10 is serrated.

The method for transport comprises providing a device having one or more rails, each rail having one or more serrated edges running the length of the top of the rail. The device is lowered to be in a position where the rails are approximately at the level of the lower portion of one or more pots. The device is moved laterally, sliding the rails in between each row of pots. The device is then raised, the underside of the outer diameter of the upper portion of each pot coming into contact with a serrated edge of a rail. The device is raised vertically further, lifting the one or more pots off the surface they were on. The serrated edge holds the one or more pots in place and prevents them from falling. The transporter moves to a desired location and then lowers the device, the underside of the outer diameter of the upper portion of each pot disconnects with the serrated edge of a rail. The device is lowered further and moved laterally away from the one or more pots.

Serrated edge means any teeth like structure or jagged edge capable of providing a grip. The rails can be made of metal or other stiff, durable material, including, but not limited to, steel, stainless steel, aluminum, composite or plastic material. A mobile transporter can be any mobile machine, such as a loader, adapted to connect to the device and is capable of vertically raising and lowering the device, in addition to laterally moving the device.

Thus, there is a shown and described a unique concept of a pot lift device and method of transport. While this description is directed to particular embodiments, it is understood that those skilled in the art may conceive modifications and/or variations to the specific embodiments shown and described herein. Any such modifications or variations, which fall within the purview of this description, are intended to be included therein as well. It is understood that the description herein is intended to be illustrative only and in not intended to be limitative. Rather, the scope of the invention described herein is limited only by the claims appended hereto.

1. A pot lift device comprising a plurality of elongated, spaced-apart, generally parallel rails extending in a horizontal manner and adapted to be raised and lowered, wherein said rails comprise a leading distal end and a proximal end, said proximal end adapted to be attached to a mobile carrying machine, said proximal end of said rails being connected by a perpendicular cross bar, said rails are spaced apart at a distance greater than a bottom diameter of a pot but less than a top diameter of said pot, said rails have on their top edge a serrated means for gripping an underside portion of said top diameter of said pot.

2. The device according to claim 1, wherein said leading distal end of said rails are tapered.

3. The device according to claim 1, wherein said rails are constructed of a rigid and highly-durable material.

4. The device according to claim 1, wherein said rails comprise steel.

5. The device according to claim 1, wherein said rails comprise stainless steel.

6. The device according to claim 1, wherein said rails comprise aluminum.

7. The device according to claim 1, wherein said rails comprise a composite material.

8. The device according to claim 1, wherein said mobile carrying machine comprises a loader.

9. A method of transporting a pot comprising:
a) providing a plurality of elongated, spaced-apart, generally parallel rails extending in a horizontal manner and adapted to be raised and lowered, said rails comprising a leading distal end and a proximal end, said proximal end adapted to be attached to a mobile carrying machine, said proximal end of said rails being connected by a perpendicular cross bar, said rails being spaced apart at a distance greater than a bottom diameter of a pot but less than a top diameter of said pot, said rails having on their top edge a serrated means for gripping an underside portion of said top diameter of said pot;
b) positioning said rails underneath said underside portion of said top diameter of said pot;
c) raising said rails wherein said serrated means for griping come in contact with said underside portion of said top diameter of said pot; and
d) raising said rails further, wherein said pot is supported solely by said rails.
e) transporting said pot laterally to a desired location.
f) lowering said rails, wherein said gripping means break contact with said underside portion of said top diameter of said pot.

10. The method according to claim 9, wherein said leading distal end of said rails are tapered.

11. The method according to claim 9, wherein said rails are constructed of a rigid and highly-durable material.

12. The method according to claim 9, wherein said rails comprise steel.

13. The method according to claim 9, wherein said rails comprise stainless steel.

14. The method according to claim 9, wherein said rails comprise aluminum.

15. The device according to claim 9, wherein said rails comprise a composite material.
